(19) United States
(12) Patent Application Publication
(10) Pub. No.: US 2024/0297474 A1
(43) Pub. Date: Sep. 5, 2024

(54) SHUTTER APPARATUS HAVING PORTS TO CONTROL ENERGY BEAM AND GAS TRANSFER BETWEEN ZONES

(71) Applicant: XCIMER ENERGY, INC., Redwood City, CA (US)

(72) Inventors: Cyrus M. Herring, Tolono, IL (US); Steven Franklin Pugh, Charlotte, NC (US); Chet Alister Johnston, Ramona, CA (US)

(21) Appl. No.: 18/592,359

(22) Filed: Feb. 29, 2024

Related U.S. Application Data
(60) Provisional application No. 63/449,282, filed on Mar. 1, 2023.

(51) Int. Cl. H01S 3/036; H01S 3/04

(52) U.S. Cl. CPC H01S 3/036; H01S 3/0401

(57) ABSTRACT

A shutter apparatus and method that intermittently establishes a pathway between a first zone having a high pressure atmosphere and a second zone having a low pressure atmosphere. The shutter apparatus includes a first port adjacent to the high pressure atmosphere and a second port adjacent to the low pressure atmosphere. An actuator of the shutter apparatus opens and closes off the first port to the second port to establish the pathway and permit transmission of an energy beam between the zones while minimizing transfer of gas from the high pressure atmosphere to the low pressure atmosphere.

This application claims the benefit of priority of U.S. Provisional Patent Application No. 63/449,282, filed on Mar. 1, 2023, titled “Time Of Flight Gas Shutter To Transmit A Light Or Particle Beam From One Atmosphere Into Another Of Different Atmosphere And/Or Pressure,” which is incorporated herein by reference in its entirety to provide continuity of disclosure.

### FIELD

The present disclosure relates to shutters and methods used to regulate the transfer of gas between atmospheres. More particularly, the present disclosure relates to a shutter apparatus and methods to transmit an energy beam, such as a laser or particle beam, between a zone having a gaseous atmosphere and a zone having a substantially evacuated atmosphere without substantial movement of gas from the gaseous atmosphere into the substantially evacuated atmosphere.

### BACKGROUND

Particle beams consisting of electrons, protons, alpha particles, etc., are typically generated in vacuum chambers, whereas laser beams are frequently generated in a gaseous atmosphere such as neon, argon, or a mixture of gases such as room air. There may be a need to transmit the energy beams into a different atmosphere or environment, such as from a gaseous environment into a vacuum chamber, or from a vacuum chamber into a gaseous environment. In some situations, the beam can be transmitted between the atmospheres through a window physically separating the two environments, where the window is transparent to the beam and can withstand the pressure of the gas pushing towards the vacuum. In this context transparent means that the beam will pass through the window without meaningful distortion or loss of energy. However, in other cases the window will not be transparent for one or more of many reasons. For example, the application may require that there be little or no distortion of the beam or loss of energy from the beam between the environment in which the beam is generated, e.g., the gaseous environment, and the environment where the target of the beam is located, e.g., the vacuum chamber. In this situation, it is desired to transmit the beam from the environment in which it is generated, directly to the target in the other environment with minimal or insubstantial transmission of gas between the environments.

Some techniques to achieve beams passing from a vacuum environment into a gaseous environment (or passing from a pressurized environment into a vacuum environment) involve using aerodynamic windows or plasma windows when it is desirable not to have a solid material separating the vacuum from the gaseous environment. However, this technique is limited to small areas (˜4 square inch or smaller) and the techniques are energy intensive.

### BRIEF DESCRIPTION OF THE DRAWINGS

FIG. 1 depicts a cross-sectional view of a shutter apparatus, in accordance with an embodiment;

FIGS. 2A and 2B depicts a top view of a shutter apparatus, in accordance with an embodiment;

FIG. 3 depicts cross-sectional view of a shutter apparatus, in accordance with an embodiment;

FIGS. 4A and 4B depict a perspective view of a shutter apparatus, in accordance with the embodiment depicted in FIG. 3; and

FIG. 5 depicts a flowchart of a method of using a shutter apparatus to control energy beam and gas transfer between atmospheres, in accordance with an embodiment.

### DETAILED DESCRIPTION

The following description sets forth numerous specific details such as examples of specific systems, components, methods, and so forth, in order to provide a good understanding of embodiments of the present invention. It will be apparent to one skilled in the art, however, that at least some embodiments may be practiced without these specific details. In other instances, well-known components or methods are not described in detail in order to avoid unnecessarily obscuring the description of the exemplary embodiments. Thus, the specific details set forth are merely exemplary. Particular implementations may vary from these exemplary details and still be contemplated to be within the scope of the present invention.

In laser-based inertial fusion reactions, one or more high-energy pulsed laser beams impact a fuel pellet, such as a deuterium-tritium fuel pellet, to start ignition. The laser beam(s) are typically focused down from a large area to a small area the size of the target. The laser beam will start at a low power density (W/cm²) and be focused down to high power densities. At some point, as the laser becomes more focused, and more intense, it will begin to break down air, or any gas due to non-linear multi-photon processes. This absorption would cause a redirection and scattering of the laser beam energy and meaningfully reduce the laser energy that reaches the target. This non-linear breakdown process is even more pronounced when passing through a solid material, such as a vacuum window used to separate a gaseous environment from a vacuum environment. These effects can cause damage to solid window materials, and avoiding excessive optical damage to such windows can be a significant constraint in the design of inertial fusion systems. Therefore, it may be desirable to transition the laser beam from a gaseous environment, where the laser beam originates, into a vacuum chamber, where the fusion fuel is located, without the use of a transparent window to separate the two environments.

In order to sustain energy production by fusion, multiple fuel pellets/targets can be ignited in succession. The fuel pellet may be located in a near-vacuum environment (˜1×10⁻³ Torr or less, e.g., 10⁻⁴ Torr). Placing a solid window between the gaseous atmosphere where the laser beams are generated and the evacuated atmosphere where the target fuel cell is located may distort or attenuate the energy of the beam such that ignition may not reliably occur on a shot-over-shot basis as desired to maintain the desired periodic ignition as fuel cells enter the ignition chamber (not shown). Furthermore, a solid window may accumulate optical damage and require replacement. The skilled artisan will appreciate that the embodiment described herein can be used for transmission of any energy beam (a light beam or a particle beam for example) from a gaseous atmosphere into an evacuated atmosphere, or vice versa, and the description for transmission of laser energy to ignite fuel pellets is exemplary. More particularly, the shutter apparatus and method described below may be used for transmission of particle energy between an evacuated atmosphere and a gaseous atmosphere, as well as for applications other than inertial fusion reactions.

In the following description and in the accompanying drawings, specific terminology and reference numbers are set forth to provide a thorough understanding of embodiments of the present invention. In some instances, the terminology and symbols may imply specific details that are not required to practice the invention.

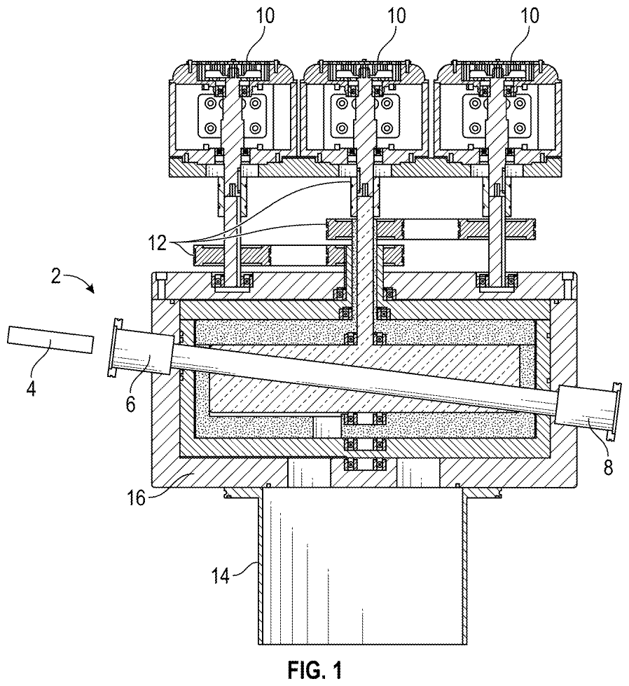

FIG. 1 shows a schematic of a shutter apparatus 2 in accordance with an embodiment. The shutter apparatus 2 can be a periodic time-of-flight apparatus that can allow several laser pulses to transmit from a first zone, e.g., a chamber, a body, a housing, or another structure, containing a higher pressure gaseous environment to a second zone, e.g., a second chamber, a second body, a second housing, or another structure, containing a substantially evacuated atmosphere (vacuum) environment. The several laser pulses can transmit through a shutter that periodically opens and closes, as described below. It will be appreciated that the shutter apparatus 2 may alternatively allow for transmission of a single laser pulse between atmospheres, in which case the apparatus may be considered a pulsed time-of-flight shutter apparatus. In either case, the shutter apparatus 2 operates to permit transmission of an energy beam from the first zone, e.g., the structure having a first atmosphere having a first (e.g., higher) pressure, to the second zone, e.g., the second structure having a second atmosphere having a second (e.g., lower) pressure. As described below, such transmission may occur during a shutter open time that minimizes transfer of gas between the first atmosphere and the second atmosphere, e.g., from the first atmosphere to the second atmosphere.

In an embodiment, a laser beam 4 is directed into shutter apparatus 2. For example, the shutter apparatus 2 can be incorporated in a fusion system. The fusion system may, for example, be an inertial confinement fusion (ICF) system. The ICF system may operate on a single-shot, non-repetitive basis. Alternatively, the fusion system may be an inertial fusion energy (IFE) system. The IFE system may operate continuously, in a pulsed fashion, e.g., at a frequency of one shot per second. Accordingly, the laser beam 4 and the shutter apparatus 2 may be incorporated into any system having architecture to perform a fusion process. The fusion system can include an energy pulse source, such as a laser. The laser can generate and direct the laser beam 4 toward the shutter apparatus 2.

Shutter apparatus 2 can include a first port, e.g., a shutter port 6, adjacent to or exposed to a first atmosphere. The first atmosphere can be a higher pressure gaseous environment (such as neon, helium, or air) where the laser is generated. More particularly, the first atmosphere can contain a gas and have a first pressure, e.g., a pressure higher than 1×10⁻³ Torr.

The laser beam 4 may be directed through shutter apparatus 2 to transmit from the first atmosphere in the first zone to a second atmosphere in the second zone. More particularly, the shutter apparatus 2 can have a second port, e.g., a shutter port 8, adjacent to or exposed to a second atmosphere. The second atmosphere can be a lower pressure evacuated environment where the target is located. More particularly, the second atmosphere can have a second pressure, e.g., a pressure less than 1×10⁻³ Torr. The laser beam 4 can transmit through a channel or space interconnecting the shutter port 6 and the shutter port 8, and out of the shutter port 8 into the second atmosphere. More particularly, the laser beam 4 can transmit through the shutter port 6 and the shutter port 8, when the ports are at least partially open or at least partially open to each other during a shutter open time, to impact the target.

Shutter port 6 and shutter port 8 can open and close to respective environments at respective frequencies. For example, shutter port 6 can alternatingly open and close to the first environment having the higher pressure at a first frequency, and shutter port 8 can open and close to the second environment having the lower pressure at a second frequency. In an embodiment, shutter port 6 or shutter port 8 can be closed a majority of the time. For example, one or more of shutter port 6 or shutter port 8 may be closed more than 50% of the time, more than 75% of the time, more than 90% of the time, or more than 99% of the time, e.g., at least 99.5% of the time. The first frequency and the second frequency may be the same or different. In any case, however, the shutter ports may periodically align or otherwise open to each other. More particularly, the shutter ports 6, 8 of the shutter apparatus 2 may be controlled to intermittently open and close off or to intermittently open and close off to each other. When the shutter ports are open or open to each other, the ports can be coupled, e.g., placed in fluid communication with each other. When the ports are closed off or closed off to each other, the ports can be decoupled, e.g., not in fluid communication with each other.

In an embodiment, the shutter port 6 and the shutter port 8 are intermittently opened and closed off for a shutter open time. During such time, the shutter port 6 is intermittently opened and closed off to the shutter port 8 for the shutter open time. During the shutter open time, the ports 6, 8 are simultaneously at least partially open to each other to create an opening or pathway to let the laser pulse pass through the ports from the first atmosphere to the second atmosphere. The shutter open time can be based on the respective frequencies at which the shutter ports 6, 8 open and close to their respective environments. When the shutter ports 6 or the shutter port 8 closes, the ports are no longer open to each other and the shutter apparatus 2 closes once again, restricting the transmission of energy and the flow of gas between the environments.

In an embodiment, shutter ports 6 and 8 operate in tandem, e.g., are controlled to open and close in coordination, to both open and subsequently shut before gas can traverse a distance between them. More particularly, the shutter port 6 and the shutter port 8 can be separated by the distance, and the distance may be longer than a distance over which the gas can traverse during the shutter open time. The shutter open time, e.g., the duration beginning when the shutter port 6 opens to the shutter port 8 and ending when the shutter port 6 closes off to the shutter port 8, can be based on the first frequency of the shutter port 6 and the second frequency of the shutter port 8. More particularly, the frequencies at which the ports open and close in time can determine an overlap in time during which the ports are simultaneously at least partially open to each other. The frequency shutter ports 6 and 8 align to open and close may be selected in accordance with the application chosen, and provides the ability to prevent or substantially reduce gases from transferring between the gaseous side and the evacuated side, e.g., by crossing from the gaseous side into the evacuated side.

The shutter apparatus 2 can include mechanisms selected by the skilled artisan to suit the need of the chosen application and may be comprised of gate valves, moving pistons with holes that block the beam at certain times, or rotating cylinders with holes that align with the ports, or rotating disks that have holes that align with the ports. The shutter apparatus 2 can include one or more actuators to intermittently open and close off the shutter port 6 to the shutter port 8. For example, as shown in FIG. 1, drive motors 10 can turn a drum or disc (described below) of shutter apparatus 2, using belt-drive transmission 12, to open and close the shutter ports 6, 8 for the shutter open time. It will be appreciated that the shutter apparatus 2 may be controlled by a control system. For example, the control system can include one or more processing devices to cause the shutter apparatus 2 (or a system incorporating the shutter apparatus 2) to perform the method described below. In an embodiment, the control system includes a non-transitory computer-readable medium having instructions which, when executed by a processing device of the control system, cause the shutter apparatus 2 (or a system incorporating the shutter apparatus 2) to perform the method described below

The shutter apparatus 2 and/or a system incorporating the shutter apparatus 2 (such as a fusion system) can incorporate additional components to facilitate energy transmission and limit gas transfer between the atmospheres that are intermittently, fluidly conjoined by the shutter apparatus 2. As described below, the shutter apparatus 2 can minimize transfer of gas between the first atmosphere and the second atmosphere, e.g., from the first atmosphere to the second atmosphere. Minimizing transfer can include limiting gas transfer through shutter port 8 to an amount such that the lower pressure in the second atmosphere is maintained below an operational pressure of the system, e.g., at a pressure of 1×10⁻³ Torr or less. It will be appreciated that some gas will transfer into the channel coupling the shutter ports 6, 8, however, and it may be beneficial to evacuate such gas during a period of time in which the ports are closed off to each other. Accordingly, shutter apparatus 2 can include a vacuum pump port 14 through which gas can be evacuated. More particularly, a vacuum pump may evacuate gas trapped in shutter apparatus 2 during the time the ports are aligned and then subsequently closed to maintain a pressure of the channel at an intermediate pressure between the higher pressure of the first atmosphere and the lower pressure of the second atmosphere.

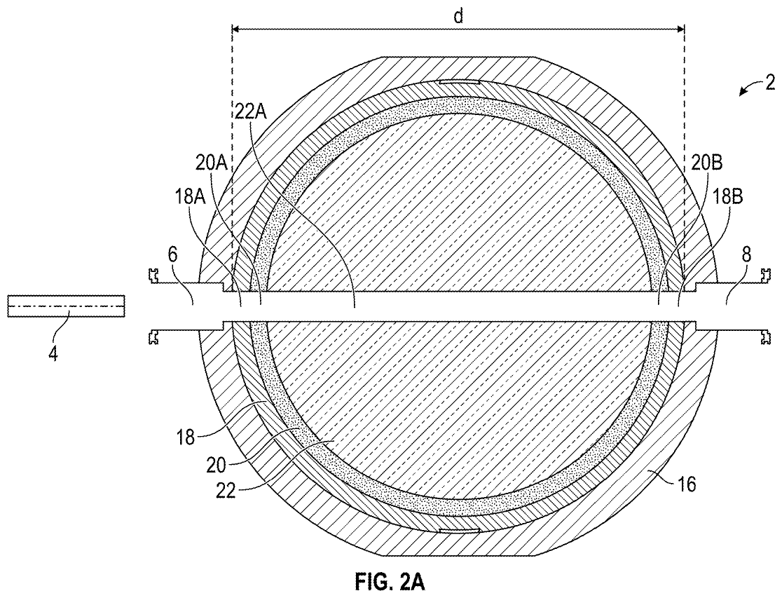

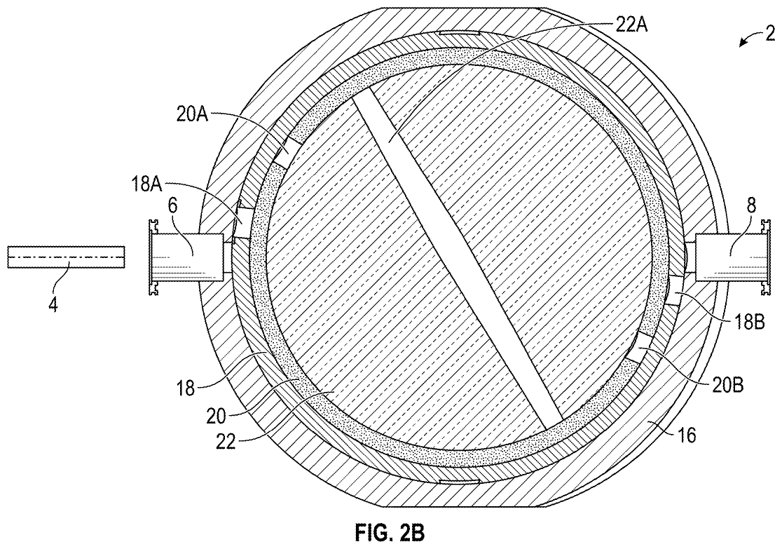

FIG. 2A illustrates a cross-section of shutter apparatus 2 in accordance with an embodiment. The shutter apparatus 2 is shown in a fully aligned state. In an embodiment, the shutter apparatus 2 includes an outer external body 16, outer drum 18, middle drum 20 and inner drum 22 located concentrically inside external body 16. As described above, external body 16 has shutter port 6 exposed to the higher-pressure environment and shutter port 8 exposed to the lower-pressure environment. Outer drum 18 comprises drum ports 18a and 18b, middle drum 20 comprises drum ports 20a and 20b, and inner drum 22 comprises drum port 22a. The body or drums can be rotatable relative to each other. For example, the outer drum 18 can be rotatable within the external body 16. Similarly, the middle drum 20 can be rotatable within the outer drum 18.

Rotation of the drums can align the drum ports with each other or with the shutter ports 6, 8 of the outer external body 16. For example, the outer drum 18 can rotate within the outer external body 16 to align the drum port 18A with the shutter port 6 and the shutter port 8. The ports can align along a line of sight. More particularly, the shutter port 6 and the shutter port 8 can be longitudinally aligned and separated by the distance along a line of sight axis. The line of sight axis may be the axis along which the energy beam 4 travels, and the ports can be aligned when the line of sight axis extends through the ports (allowing the energy beam 4 to pass through the aligned ports). When the shutter port 6 is aligned with the drum port 18A, the shutter port 6 can be open to the shutter port 8 through the drum port 18A.

Opening the shutter port 6 to the shutter port 8 can require additional ports of the shutter apparatus 2 to align. For example, the middle drum 20 may rotate to move the drum port 20A with the drum port 18A. When the drum ports 18A, 20A are aligned, along the line of sight axis, the shutter port 6 can open to the shutter port 8 and the energy beam 4 can travel through the shutter apparatus 2 from the higher pressure atmosphere to the lower pressure atmosphere.

Each of the drums can rotate in a same direction. For example, the speed of rotation of each drum can be independently controlled, e.g., by independent motors or a gear system interlinking the drums, to rotate in a clockwise direction at respective rotational frequencies. The channel having a length equal to the distance separating the shutter port 6 and the shutter port 8 can be created when all the drum ports align to create a free opening or pathway (having a length equal to the distance) between shutter ports 6 and 8, such that laser beam 4 may pass through shutter apparatus 2 from the higher-pressure environment to the lower pressure environment and to impact the target (not shown).

The rotational speeds of outer drum 18, middle drum 20 and inner drum 22 can be set such that the alignment of the drum ports 18A, 20A, and 22A occurs at a predetermined periodicity. The periodicity can be selected such that alignment of the ports, or the port opening caused by such alignment, does not exist for a sufficient time to permit the gas (e.g., neon or helium) to pass along the full distance between the shutter ports 6, 8. Gas transmission is a function of the molecular velocity of the gas, e.g., V_{M}. Thus, if the distance, d, is greater than the molecular velocity of the gas times the time, t₀, during which the ports are aligned or open to each other, then the direct pathway between the gaseous and evacuated sides will not be open sufficiently long to permit gas to travel into the evacuated environment. With this in mind, transfer of gas between the first atmosphere and the second atmosphere, e.g., from the first atmosphere to the second atmosphere, can be minimized by observing the governing equation: d>(V_{M})*(tₒ). More particularly, gas transfer can be minimized by selecting an appropriate distance between the ports.

Instead of or in addition to controlling distance between the shutters to limit gas transfer between atmospheres, the gas transfer may also be minimized by controlling the shutter open time of the shutter apparatus 2. A free path transit time, t_{fp}, of the gas across a given distance, d, can be defined as t_{fp}=d/V_{M}. When the free path transit time for the gas to travel across the distance between the shutter ports 6, 8 is less than the shutter open time of the shutter apparatus 2, then the gas will not travel entirely through the channel into the second atmosphere. More particularly, gas transfer between the atmospheres can be minimized or eliminated by setting the shutter open time to be less than the free path transit time.

Any gas trapped in shutter apparatus 2 during the period of port alignment will be substantially evacuated before the next port alignment occurs. As will be appreciated seals can be placed between rotating parts. The seals can allow the rotating parts to rotate at high rotational speeds while maintaining adequate seals between each of the rotating parts. The seals can be between some or all of the rotating parts. In an embodiment, a linear velocity between moving parts can be less than ˜1,000 feet per minute to allow seals to be inserted between the moving parts. The speed between the external body 16 and the outer drum 18 may cause failure of a physical seal. Accordingly, other means can be employed, as described below, to reduce a likelihood of gas leaking or an amount of gas transferring between the pressurized environment and the evacuated environment, e.g., traveling from the pressurized environment to the evacuated environment.

In an embodiment, the free path transit time can be increased by increasing the distance between the shutter ports 6, 8. For example, the rotational angle of the drums and ports can be set at an off-axis angle, e.g., 45 degrees, to increase the distance between the shutter ports 6, 8 through which the energy beam 4 passes. The increased distance increases the shutter open time that the direct pathway may remain open between the ports without permitting gas into the evacuated environment.

FIG. 2B illustrates a cross-section of shutter apparatus 2 in a non-aligned state. The drums 18, 20, 22 can rotate relative to each other to move respective ports into misalignment with each other. More particularly, note that the line of sight axis along which the energy beam 4 is directed does not pass through the drum ports 18A, 20A, and 22A. In the non-aligned state, the ports may be closed off to each other, and neither the energy beam 4 nor the gas can travel between the shutter port 6 and the shutter port 8, e.g., from the shutter port 6 to the shutter port 8.

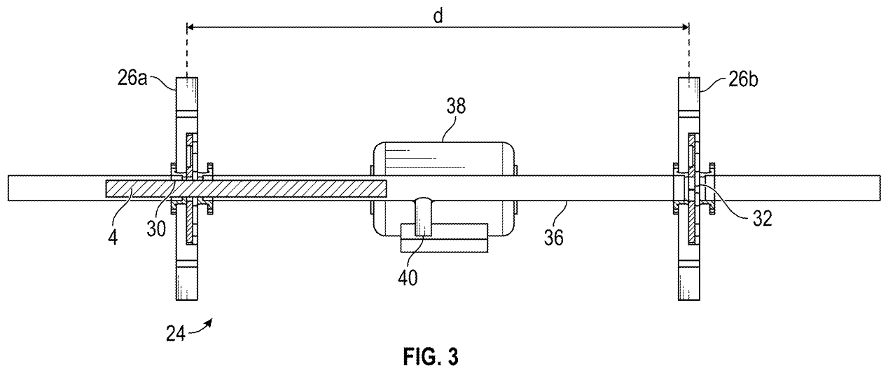

FIG. 3 shows an alternative embodiment. Shutter apparatus 24 can include a first disc, e.g., a disc of disc-shutter 26a, and a second disc, e.g., a disc of disc-shutter 26b. The shutter apparatus 24 can include an entrance-port 30, e.g., at the first disc, and an exit-port 32, e.g., at the second disc. A transmission-pipe 36 having the channel of a length or distance that connects the entrance-and exit-ports 30 and 32 can extend from the entrance port 30 to the exit port 32. The shutter apparatus 24 can include one or more actuators, such as a motor 38, to spin the discs (discussed below) of disc-shutters 26a and 26b.

As with other embodiments, energy beam 4, e.g., a laser beam, enters entrance- port 30 from a higher-pressure environment and exits exit-port 32 into a lower-pressure environment unimpeded by physical barriers (e.g., windows) to impact a target (not shown) when shutter apparatus 24 is in the aligned-or open-state. Entry-and exit-ports 30 and 32 can be independently opened and closed periodically. When the ports 30, 32 simultaneously open, the ports can be opened to each other. The shutter open time, when the ports are both in the open-state and in fluid communication with each other, may not be sufficiently long enough to permit gas from the higher pressure environment to travel the distance between the ports 30, 32 into the lower-pressure environment. Any gas trapped between the ports when in the closed-state can be pumped out through pump-port 40.

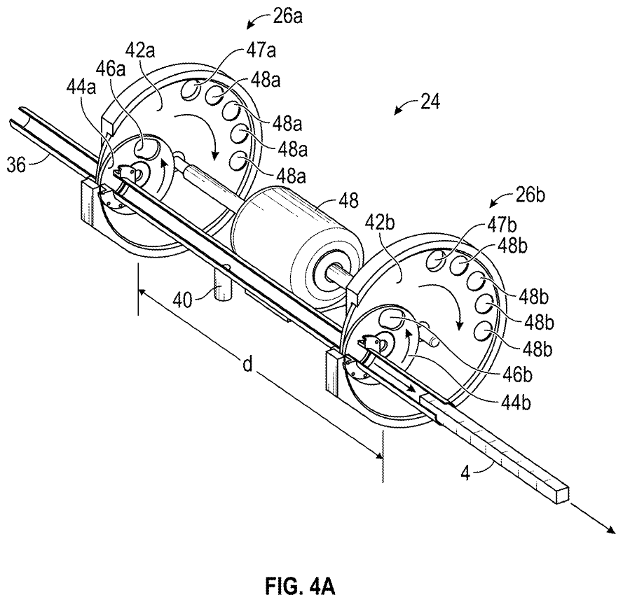

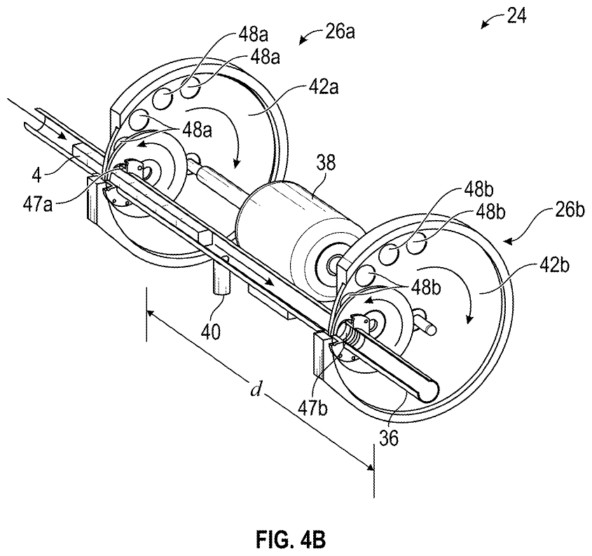

FIGS. 4A and 4B shows an oblique view of shutter apparatus 24 in the closed and open state, respectively. Disc-shutters 26a and 26b can have a same or similar design. Each of the disc-shutters 26a, 26b can having respective discs that rotate relative to each other to align the ports 30, 32 to open the entrance port to the exit port. Given the similarity between the disc-shutters, to facilitate the description, each part of the disc-shutters will be referenced by the same number differentiated by “a” or “b” and it will be appreciated that the description of one disc-shutter component may be extended to a component of the other disc-shutter.

Disc-shutter 26a can include larger-disc 42a and smaller-disc 44a. Smaller-disc 44a can have a noncircular-shutter 46a which is a hole and devoid of material. Larger-disc 42a can have several windows. The windows can include a circular-shutter 47a and, in an embodiment, four circular-windows 48a. The circular-shutter 47a can be a void or opening and circular-windows 48a may be of a light-transparent material to permit viewing down the length of transmission-pipe 36 when aligned with non-circular shutter 46a.

In an embodiment, larger-disc 42a and smaller-disc 44a spin in opposite directions (shown by arrows) and by virtue of their different diameters, non-circular-shutter 46a aligns with circular-windows 48a and circular-shutter 47a sequentially at a predetermined periodicity. As the skilled artisan will now appreciate, motor 38 spins larger-discs 42a and 42b and smaller-discs 44a and 44b at a predetermined speed, where (at some predetermined time/period) non-circular shutters 46a and 46b and the first of the four circular-windows 48a and 48b align thereby permitting a visual pathway along transmission-pipe 36 in which to view the target chamber (not shown). More particularly, the discs can rotate relative to each other to align the entrance port 46a with the windows 47a and 48b, allowing for a line of sight through the channel 36. As the larger and smaller discs continue to turn the windows are sequentially brought into alignment with the entrance port 46a. For example, the second of the four circular-windows 48a and 48b align with non-circular shutters 46a and 46b permitting a second visual pathway along transmission-pipe 36. The visual pathways through the openings and windows in the discs permits intermittent visual inspection of the chamber (not shown) and the target placement within the chamber.

The discs can rotate into a position in which non-circular shutters 46a and 46b align with circular-shutters 47a and 47b, at approximately the time energy beam 4 enters entrance-port 30. In the aligned and open state of the shutters, energy beam 4 has free passage down the now open transmission-pipe 36, and can exit exit-port 32 to impact the target (not shown) in the evacuated target chamber (not shown).

As described previously, the open state does not exist long enough for gas from the gaseous environment to travel the distance between the ports to exit into the evacuated environment. More particularly, the free path transit time of the gas through the shutter apparatus 24 can be greater than the shutter open time when the non-circular shutters 46a and 46b are aligned or open to circular shutter 47a and 47b. As described above, the free path transit time is a function of the molecular velocity of the gas.

Any gas trapped in transmission-pipe 36 can be evacuated through port 40. In an embodiment, the shutter apparatus 24 embodiment small-discs 44a and 44b are geared to the larger-discs 42a and 42b and are spun at approximately 16 revolutions per second in the opposite direction of each other. The non-circular shutters 46a and 46b ensures that the full energy beam 4 aperture clears into the circular-shutters 47a and 47b without any impedance.

The shutter apparatus can operate to limit gas transfer from the first atmosphere in the first zone, containing the gas and having the higher pressure, to the second atmosphere in the second zone having the lower pressure. As an example, consideration will be made for a shutter apparatus operating at atmospheric pressure and room temperature designed for a laser beam shot that is <50 ns in duration with an approximate beam diameter of 50 cm at the point where it enters shutter apparatus 2. The opposite side of the apparatus can be maintained at a pressure of 1×10⁻³ Torr or less, e.g., 1×10⁻⁴ Torr. If the working atmosphere is helium, the molecular or atomic velocity of helium, V_{M(He)}, has a first value, e.g., 1368 meters per second at atmospheric pressure and room temperature, and if neon, the molecular or atomic velocity of neon, V_{M(Ne)}, has a second value lower than the first value, e.g., 612 meters per second at atmospheric pressure and room temperature. Other gasses suitable to the application will be appreciated by the skilled artisan, e.g., if nitrogen is suitable for the purpose, the molecular velocity has a third value lower than the first value and the second value, e.g., 517 meters per second at atmospheric pressure and room temperature, increasing the free path transit time through the shutter apparatus. Based on the above description, if the distance between ports 6 and 8 is about 4 meters, then it will take helium about 3 milliseconds to cross the distance, d, such that ports must start opening, fully open, then close within about 3 milliseconds to have a port open time within a duration of the free path transit time. More particularly, the ports can be in fluid communication with each other during the port open time, which is less than the free path transit time of the gas through the shutter, to reduce a likelihood that gas will travel into the second atmosphere from the first atmosphere.

The choice of gas can depend on several factors, including atomic velocity and breakdown threshold. As described above, helium can have a higher molecular or atomic velocity than nitrogen, however, a breakdown threshold of nitrogen may be lower than that of helium. Accordingly, helium may be selected over nitrogen to avoid breakdown of the gas by the laser, even though a likelihood of gas transport fully through the shutter is increased.

If the laser aperture size is about 50 centimeters across, and shutter apparatus 2 consists only of rotating outer drum 18 that passes in front of the ports 6 and 8, then drum 18 (if by itself) must be moving at about 2×50 centimeters per 3 milliseconds, or 33,300 cm/s or 333 m/s. For a drum with a port 6 having a 4 meter diameter and port 8 having a 50 cm diameter, drum 18 can rotate at a rotational frequency of about 27 revolutions per second, or 1,633 rpm. This arrangement allows ports 6 and 8 (when only drum 18 is present) to be aligned 27 times per second, which is a faster frequency than desired for this application. This alignment frequency can be reduced by adding concentric middle drum 20 and inner drum 22 inside drum 18 that rotate at the same or different speed to achieve the desired alignment. The frequency or opening/alignment can be adjusted by adding or removing more concentric drums to bring the alignment frequency to the desired value, which in an embodiment is about 1 alignment per second.

An important operational property of the inventive shutter apparatus is to minimize any leakage or passage of gas from the inlet port 6 to the outlet port 8. This gas movement can be categorized into two different flow types, ingestion, and blow-by. Ingestion is the volume or amount of gas that is transmitted into the shutter assembly during the opening phase of the ports as they come into alignment. This is the time interval when gas can directly travel into and through the vacuum shutter during all phases of the opening, as described herein. This gas may be trapped in the shutter apparatus and pumped out before the next alignment cycle. Blow-by of gas is the amount of gas that leaks around the parts during the closed portion of the alignment cycle. There are ways to minimize this flow that will be discussed below. Leakage of gas into the second atmosphere, whether through ingestion or blow-by gas, can cause an increase in the pressure of the second atmosphere. Such pressure increase can be detrimental to a reaction occurring within the second atmosphere. Accordingly, as described above, leakage of the gas, particularly by ingestion, can be limited by the shutter apparatus to facilitate operation of, e.g., a fusion system.

Concentric drums that rotate in the same direction allow for relative velocities between the rotating drums to be controlled to relatively slow speeds in a range of 1,000 to 7,000 feet per minute, e.g., 2,820 feet per minute or 14 meters per second, which may allow the use of seals between the parts to minimize gas leakage in gaps between parts. The use of seals reduces blow-by leakage around the drums. However, the outer drum 18 may have too high a rotation speed relative to the exterior, stationary wall 16 in some embodiments to permit the use of dynamic seals between the two. In such a case, tight tolerances between the pieces and special structures can be incorporated to impede and minimize the flow of gas from the inlet port 6 (at relatively high pressure) through the gaps between outer rotating drum 18 and stationary wall 16, and exiting port 8. One configuration of these special structures is to form a tortuous path for the gas traveling around the outside drum 18. The special structures may also be blades on the outside of drum 18 to pump the gas away from the low pressure region. In one embodiment there may be several stages of rotating blades interlaced with stationary blades, thereby mimicking a turbopump on the outer wall of rotating drum 18.

The relative frequencies of the concentric drums determine the time periods between full alignments. In order to maximize the alignment period and minimize any partial alignment sequences, the rotational velocities may be controlled for each drum. The drum can be divided into equal angular segments about its axis of rotation, with the number of segments denoted n, and the angle of each segment being made such that the entry aperture is contained completely within one angular segment and centered in the segment with a minimum angle. Each drum may have a different number of segments, but with a sufficiently large diameter (and small enough aperture), each drum may have the same number of segments n. The angle of each segment will equal 360/n degrees, or 2π/n radians. If the outer segment rotates one full revolution, it is desirable to have the inwardly adjacent drum travel just more than or under one full revolution by either 360+360/n degrees, or

$$360 - 360 / n degrees ( 360 ( 1 \pm \frac{1}{n} ) ) .$$

This will give an alignment between these two drums every n turns of the outer drum and with no partial alignments otherwise.

If there are three rotating concentric drums and it is desirable to maximize the period between drum alignments, then the inner drum can rotate in the same fashion as described above for two drums. Thus, in a three-drum embodiment when the outer-most drum has rotated n times, then the middle drum can rotate

$$360 ° \times ( 1 \pm \frac{1}{n} ) .$$

Then, after n rotations of the middle drum, the inner-most drum can rotate

$$360 ° \times ( 1 \pm \frac{1}{n} ) .$$

All three concentric drums in this embodiment will now align each time the outer drum rotates n² times, with no other opening or partial openings otherwise, minimizing gas transfer between the two environments.

In another embodiment the flow of gas from the high pressure side to the low pressure side may be reduced by applying a voltage between the outer rotating drum 18 and the outer stationary housing 16, to create a plasma between two narrowly separated regions between the rotating drum and stationary housing. Application of a magnetic field may cause the ions to rotate in the plasma instead of free flowing through the gap. This magnetic-plasma confinement may reduce the flow of gas through the narrow channel and between the two sides.

In another embodiment, the shutter apparatus is comprised of two sets of rotating drums, rather than one set as previously described, where each set of rotating drums have a reduced diameter than if a single set of drums is used. For the sake of clarity, the embodiments described above provided a single drum set. In alternative embodiments with more than one drum set, the distance between entrance and exit ports remains approximately the same length, e.g., approximately 4 meters as described above. There may, however, be two concentric spinning drum sets, one at the entry port 6 and a second at the exit port 89. In one exemplary embodiment, each drum set will have a smaller rotating diameter of about 1 meter, with a 2 meter separation between them. In this case, the chamber that connects the two drums will have separate pumping system to remove the gas that is trapped during each alignment cycle. In this alternative embodiment, the first drum set (at the gaseous environment side) will operate at a higher pressure than the exit drum set on the vacuum environment side. The additional distance between the two-drum set embodiment assists to reduce further the amount of blow-by since the added distance between the drum sets can be pumped with additional pumps to reduce the pressure at the input of the second drum set.

Skimmers can also be incorporated in the laser beam path in the space between the drum sets to deflect the expanding gas into the vacuum pumps. Skimmers can be incorporated between shutters, and after the last shutter to divert any escaping gas into vacuum pumps.

For target tracking, it may be beneficial to see down the laser pathway to observe the fuel pellet at times shortly before the laser is set to implode the pellet. In this case, fused silica windows may be incorporated into the walls of the concentric drums such that light can pass from the target, through the drums and into an imaging system. In this case, the windows will be carefully incorporated at specific locations in the drums to give proper overlap of the windows for specific times before laser ignition at intervals leading up to the full alignment of drum ports.

In the case where two separate drum sets are installed in the laser beam path, separated by some distance as previously described, a rotating mirror assembly can be incorporated in the beam path between the two drum sets. In this embodiment, imaging can be viewed off axis to the laser beam by using mirrors that are going in and out of the beam path when the laser is not being generated. In this embodiment, windows can be installed in the low-pressure concentric drum set and timed with the rotating mirror assembly. The timing between the two drum sets can be different to allow periodic viewing of the target chamber using the mirrors. In fact, there could be more frequent free-path line-of-sight viewings of the target since the high-pressure drum set upstream is still keeping atmospheric pressure confined outside of the rotating mirror assembly. In this case, the low-pressure drum assembly can have more frequent alignments that allow light to pass for observation. Of course, the rotating mirror assembly will have to also have openings timed at the right point to allow the passage of the laser beam.

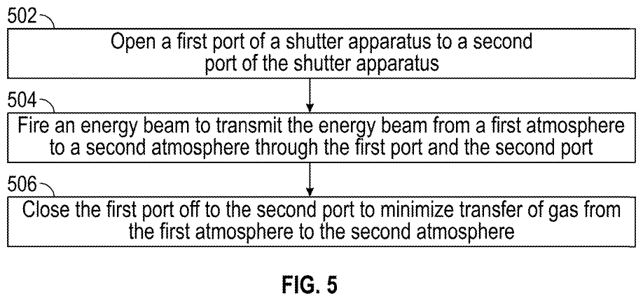

Having described the structure and function of several embodiments of a shutter apparatus above, FIG. 5 illustrates a flowchart of a method of using the shutter apparatus to control energy beam and gas transfer between atmospheres. The method is generalized to various applications. It will be appreciated, however, that the method may be used to control energy beam and gas transfer into a reaction chamber of a fusion system, in at least one embodiment.

At operation 502, a first port of a shutter apparatus is opened to a second port of the shutter apparatus at a beginning of a shutter open time. The first port can be adjacent to a first atmosphere having a first pressure and the second port can be adjacent to a second atmosphere having a second pressure. Simultaneously opening the ports can place the ports in fluid communication and form a direct optical pathway along a line of sight between the ports.

At operation 504, an energy beam is generated or fired, e.g., directed, toward the first port. The energy beam can travel along the line of sight to transmit the energy beam from the first atmosphere to the second atmosphere through the first port and the second port during the shutter open time. More particularly, the energy beam, which travels at or near the speed of light, can pass through the channel between the ports into the second atmosphere to impact the target.

At operation 506, the first port is closed off to the second port at an end of the shutter open time. Closing off the ports from each other can remove the direct optical pathway through which the energy beam and gas began to travel at the beginning of the shutter open time. The gas traveled at a substantially slower speed than the energy beam. Accordingly, when the ports are closed before the gas can travel the entire distance between the ports, no ingestion occurs into the second atmosphere. Furthermore, even when some gas leaks into the second atmosphere through the open ports, the ports can be closed quickly enough to limit such ingestion. An amount of gas leaked into the second atmosphere can be small enough so as to limit any rise in pressure in the substantially evacuated environment. Accordingly, the method can include limiting gas transfer from the first atmosphere to the second atmosphere to maintain the lower pressure at 1×10⁻³ Torr or less.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. For example, fewer or more drums or discs may be used or directions and speeds of rotation may be changed and still fit within the scope of the present invention. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A shutter apparatus, comprising:
a first port adjacent to a first zone containing a gas and having a first pressure;
a second port adjacent to a second zone having a second pressure; and
one or more actuators to intermittently open and close off the first port and the second port for a shutter open time to permit transmission of an energy beam from the first zone to the second zone through the first port and the second port, wherein the shutter open time minimizes transfer of the gas between the first zone and the second zone.

2. The shutter apparatus of claim 1, wherein the first port alternatingly opens and closes to the first environment at a first frequency, wherein the second port alternatingly opens and closes to the second environment at a second frequency, and wherein the first port simultaneously at least partially opens to the second port for the shutter open time based on the first frequency and the second frequency.

3. The shutter apparatus of claim 1, wherein the first port and the second port are separated by a distance along a line of sight, wherein the gas has a free path transit time across the distance, and wherein the shutter open time is less than the free path transit time.

4. The shutter apparatus of claim 1 further comprising a body having the first port and the second port, and a drum having a drum port, wherein the drum is rotatable within the body to align the drum port with the first port and the second port to open the first port to the second port.

5. The shutter apparatus of claim 4 further comprising a second drum having a second drum port, wherein the second drum is rotatable within the drum to align the second drum port with the drum port, the first port, and the second port to open the first port to the second port.

6. The shutter apparatus of claim 5 further comprising a third drum having a third drum port, wherein the third drum is rotatable within the second drum to align the third drum port with the drum port, the second drum port, the first port, and the second port to open the first port to the second port.

7. The shutter apparatus of claim 1 further comprising a first disc having the first port and a second disc having the second port, wherein the first disc rotates relative to the second disc to align the first port with the second port to open the first port to the second port.

8. The shutter apparatus of claim 7, wherein the second disc has a plurality of windows, and wherein the first disc rotates relative to the second disc to sequentially align the first port with the plurality of windows.

9. The shutter apparatus of claim 1, wherein minimizing transfer of the gas from the first zone to the second zone includes limiting gas transfer to maintain the second pressure at 1×10⁻³ Torr or less.

10. A fusion system, comprising:
an energy pulse source to generate an energy beam;
a first zone containing a gas and having a first pressure;
a second zone having a second pressure; and
a shutter apparatus including a first port adjacent to the first zone, a second port adjacent to the second zone, and one or more actuators to intermittently open and close off the first port and the second port for a shutter open time to permit transmission of the energy beam from the first zone to the second zone through the first port and the second port, wherein the shutter open time minimizes transfer of the gas between the first zone and the second zone.

11. The fusion system of claim 10, wherein the first port and the second port are separated by a distance along a line of sight, wherein the gas has a free path transit time across the distance, and wherein the shutter open time is less than the free path transit time.

12. The fusion system of claim 10, wherein the shutter apparatus includes a body having the first port and the second port, and a drum having a drum port, wherein the drum is rotatable within the body to align the drum port with the first port and the second port to open the first port to the second port.

13. The fusion system of claim 12, wherein the shutter apparatus includes second drum having a second drum port, wherein the second drum is rotatable within the drum to align the second drum port with the drum port, the first port, and the second port to open the first port to the second port.

14. The fusion system of claim 13 further comprising a third drum having a third drum port, wherein the third drum is rotatable within the second drum to align the third drum port with the drum port, the second drum port, the first port, and the second port to open the first port to the second port.

15. The fusion system of claim 10, wherein the shutter apparatus includes a first disc having the first port and a second disc having the second port, wherein the first disc rotates relative to the second disc to align the first port with the second port to open the first port to the second port.

16. The fusion system of claim 15, wherein the second disc has a plurality of windows, and wherein the first disc rotates relative to the second disc to sequentially align the first port with the plurality of windows.

17. The fusion system of claim 10, wherein minimizing transfer of the gas from the first zone to the second zone includes limiting gas transfer to maintain the second pressure at 1×10⁻³ Torr or less.

18. A method, comprising:
opening a first port of a shutter apparatus to a second port of the shutter apparatus at a beginning of a shutter open time, wherein the first port is adjacent to a first zone containing a gas having a first pressure and the second port is adjacent to a second zone having a second pressure;
firing an energy beam toward the first port and the second port when the first port is open to the second port to transmit the energy beam from the first zone to the second zone through the first port and the second port; and
closing the first port off to the second port at an end of the shutter open time to minimize transfer of the gas between the first zone and the second zone.

19. The method of claim 18, wherein the first port and the second port are separated by a distance along a line of sight, wherein the gas has a free path transit time across the distance, and wherein the shutter open time is less than the free path transit time.

20. The method of claim 18, wherein the shutter apparatus includes a body having the first port and the second port, and a drum having a drum port, and further comprising rotating the drum within the body to align the drum port with the first port and the second port to open the first port to the second port.

21. The method of claim 18, wherein the shutter apparatus includes a first disc having the first port and a second disc having the second port, and further comprising rotating the first disc relative to the second disc to align the first port with the second port to open the first port to the second port.

22. The method of claim 18 further comprising limiting gas transfer from the first zone to the second zone to maintain the second pressure at 1×10⁻³ Torr or less.
